(19) United States
(12) Patent Application Publication
(10) Pub. No.: US 2023/0085105 A1
(43) Pub. Date: Mar. 16, 2023

(54) INTELLIGENT ACTIVELY COOLED TOTE

(71) Applicant: Phononic, Inc., Durham, NC (US)

(72) Inventors: Jesse W. Edwards, Wake Forest, NC (US); Abhishek Yadav, Cary, NC (US); Devon Newman, Salt Lake City, UT (US); Austin J. Lewis, Sherman, TX (US); Simbarashe Nyika, Durham, NC (US); Dana Krug, Lenexa, KS (US); Robert Therrien, Durham, NC (US); Edward Karwacki, Garner, NC (US); Frank Holton, Morrisville, NC (US); JoAnna Heineck, Durham, NC (US)

(21) Appl. No.: 17/945,931

(22) Filed: Sep. 15, 2022

Related U.S. Application Data
(60) Provisional application No. 63/244,518, filed on Sep. 15, 2021.
(60) Provisional application No. 63/402,862, filed on Aug. 31, 2022.

(51) Int. Cl. B65G 1/137

(52) U.S. Cl. CPC B65G 1/137; G06Q 10/0832

(57) ABSTRACT

Systems and methods for cold chain deliveries are provided. In some embodiments, a method of operating a tote to enable cold chain delivery, the method comprising one or more of: providing storage of one or more cold products in the tote in a micro-fulfillment center; facilitating a pick and pack process of one or more cold products where the one or more cold products are picked from a tote and/or are packed into a tote; and dispensing the one or more cold products using a tote. In this way, cold chain requirement compliance is improved while saving time, money, and energy.

### RELATED APPLICATIONS

This application claims the benefit of provisional patent application Ser. No. 63/244,518, filed Sep. 15, 2021, the disclosure of which is hereby incorporated herein by reference in its entirety.

This application claims the benefit of provisional patent application Ser. No. 63/402,862, filed Aug. 31, 2022, the disclosure of which is hereby incorporated herein by reference in its entirety.

### FIELD OF THE DISCLOSURE

The present disclosure relates to cold chain deliveries.

### BACKGROUND

Recent events have led to exponential growth in fulfillment across numerous sectors—especially grocery. And it is not slowing down. It is accelerating. Online grocery sales will account for 21.5% of total grocery sales by 2025, at an estimate of $250 billion, which would be a 60% increase compared to 2020 estimates. In 2020, adoption rates of online grocery shopping had increased, with average online order value of over $115 per order.

Grocery supply chains are some of the most complex in the industry.

Product shelf life, fragility, and temperature requirements present unavoidable challenges. Yet, groceries serve one of the most ubiquitous demands of any supply chain. There is a need to look at ecommerce fulfillment as one system, which is sometimes referred to herein as the cold chain ecommerce ecosystem.

Improved systems and methods for cold chain deliveries are needed.

### SUMMARY

Systems and methods for cold chain deliveries are provided. In some embodiments, a method of operating a tote to enable cold chain delivery, the method comprising one or more of: providing storage of one or more cold products in the tote in a micro-fulfillment center; facilitating a pick and pack process of one or more cold products where the one or more cold products are picked from a tote and/or are packed into a tote; and dispensing the one or more cold products using a tote. In this way, cold chain requirement compliance is improved while saving time, money, and energy.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the disclosure, and together with the description serve to explain the principles of the disclosure.

FIGS. 1A-1D illustrate utilization of a portable, self-contained, refrigeration or freezing system, coupled with integrated automated controls and monitoring;

FIG. 2 and FIGS. 3A and 3B illustrate an example embodiment of an active cooler in accordance with embodiments of the present disclosure;

FIG. 4 illustrates a system including an active cooler in accordance with some embodiments of the present disclosure;

FIG. 5 is a flow chart for communication and control of an active cooler in accordance with some embodiments of the present disclosure;

FIG. 6 illustrates an embodiment where a fulfillment center includes three separate temperature areas, according to some embodiments of the present disclosure;

FIG. 7 illustrates an overview of the cold chain ecosystem, according to some embodiments of the present disclosure;

FIG. 8 illustrates automated systems used with three different temperature areas, according to some embodiments of the present disclosure;

FIG. 9 shows room temperature storage and refrigeration/freezer spaces, according to some embodiments of the present disclosure;

FIG. 10 shows a pickup center that could be the outside of FIG. 9, for instance, according to some embodiments of the present disclosure;

FIG. 11 illustrates a home delivery embodiment, according to some embodiments of the present disclosure;

FIG. 12 illustrates a pickup locker, according to some embodiments of the present disclosure;

FIG. 13 illustrates an example of a tote, according to some embodiments of the present disclosure;

FIG. 14 illustrates that different versions of the totes could be used in refrigerator or freezer versions, according to some embodiments of the present disclosure;

FIG. 15 shows an exploded view of the tote that includes a thermoelectric unit as discussed herein, according to some embodiments of the present disclosure;

FIG. 16 shows individual thermoelectric units included on a board as part of the unit, according to some embodiments of the present disclosure;

FIG. 17 shows room temperature storage and refrigeration/freezer spaces, according to some embodiments of the present disclosure;

FIG. 18 illustrates picking products directly into a tote, according to some embodiments of the present disclosure;

FIG. 19 shows a pickup center where the various totes are maintaining the temperatures instead of having three separate temperature areas, according to some embodiments of the present disclosure;

FIG. 20 shows various types of totes stored in the same racks with additional features that might make automatic systems more efficient, according to some embodiments of the present disclosure;

FIG. 21 illustrates an automated environment for a micro fulfillment center with three different temperature zones, according to some embodiments of the present disclosure;

FIG. 22 illustrates an automated environment for a micro fulfillment center with only one temperature zone necessary since the totes can maintain the proper temperatures, according to some embodiments of the present disclosure;

FIG. 23 shows an order pick up area where the totes maintain the temperature and the lockers do not need to be temperature controlled, according to some embodiments of the present disclosure;

FIG. 24 shows a delivery service where the orders are included in the back seat, according to some embodiments of the present disclosure;

FIG. 25 shows the use of the totes to deliver the orders, according to some embodiments of the present disclosure;

FIG. 26 illustrates an embodiment where the tote can be left with the delivery to further increase the time that the order is the correct temperature, according to some embodiments of the present disclosure;

FIG. 27 shows the standard tri-temperature truck that is used for deliveries, according to some embodiments of the present disclosure;

FIG. 28 illustrates a delivery truck which does not need refrigeration systems or needs less;

FIG. 29 shows different uses for the totes, according to some embodiments of the present disclosure; and

FIG. 30 and FIG. 31 illustrate various ways that vent ducting can be integrated into a tote rack.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

It should be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It should also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

It should be understood that, although the terms “upper,” “lower,” “bottom,” “intermediate,” “middle,” “top,” and the like may be used herein to describe various elements, these elements should not be limited by these terms. These terms are only used to distinguish one element from another. For example, a first element could be termed an “upper” element and, similarly, a second element could be termed an “upper” element depending on the relative orientations of these elements, without departing from the scope of the present disclosure.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having meanings that are consistent with their meanings in the context of this specification and the relevant art and will not be interpreted in an idealized or overly formal sense unless expressly so defined herein.

In some embodiments herein, the ecosystem is defined as the point of decanting products from inbound trucks and placing them into the fulfillment system until it reaches the consumer.

This includes storage, such as Micro Fulfillment centers, the pick and pack process as used for grocery retail and Hub & Spoke, and the dispensing of goods, pick up locations—curbside or lockers, transportation, as well as delivery to home, office, or other pick up locations.

The ecosystem can be broken down further into three sectors, but in most cases they will overlap in some capacity which is why you need to view the problem and solution as a cold chain ecommerce ecosystem.

Automated Systems:

This includes the Micro Fulfillment Centers (also referred to as MFCs) and Automated supermarkets.

Hub and spoke transport

Manual Fulfillment:

This includes the manual picking of items on the sales floor.

The storage of these items on store racks.

And pick up of online grocery or RX orders via curbside delivery or secure lockers.

Delivery:

Direct delivery to customers or to pick-up points via store owned transport.

Logistics supplier companies such as UPS.

Crowdsourced delivery services such as Instacart or Uber.

Hub to spoke logistic suppliers.

Unassisted drop boxes such as lockers, home porch containers, or businesses.

The fulfillment ecosystem is complex in a standard one temperature environment. When you add in the need for cold chain compliance that requires chilled, frozen, and ambient items to be filled in almost every order, it gets infinitely more complex to reduce touches or transfers that can compromise the cold chain, increase cost or increase errors.

What if there were a way to remove the need to maintain three separate temperatures zones as a barrier to designing the best and least cost fulfillment process? What if there were a storage picking and transport technology that would allow you to reduce touches and transfers while maintaining the cold chain through the entire process?

Now there is. In some embodiments herein, an Intelligent Actively-Cooled Tote provides a comprehensive solution for active cooling and freezing, delivering cold chain integrity across the entire fulfillment ecosystem.

Some embodiments include solid-state cooling which is modular and compact, with no vibration, always maintaining a uniform temperature. It is the most reliable, quiet, and sustainable cooling technology available. This thermoelectric cooling technology is the first and only mobile-cooling platform developed without a compressor. The totes utilize sustainable cooling—using just water and CO2 (for example) as a refrigerant. And since this solution is compressor-free, interior capacity is maximized.

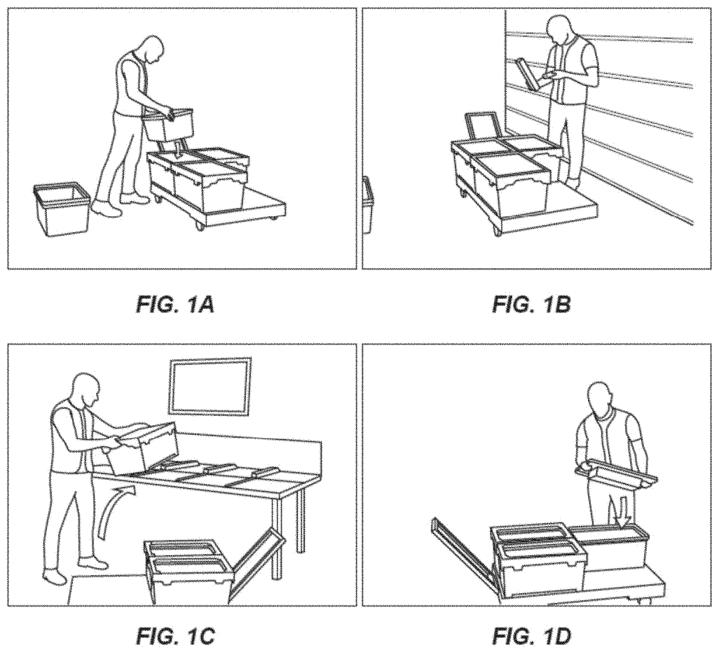

FIGS. 1A-1D illustrate utilization of a portable, self-contained, refrigeration or freezing system, coupled with integrated automated controls and monitoring. In some embodiments, containers with goods can be loaded into other containers. These containers can be wirelessly controlled and tracked. In some embodiments, these containers can be attached to inventory control areas and/or areas that provide power to the containers. In some embodiments, a removable module can include the thermoelectric device and associated control mechanisms. This can be added to an insulated container to provide active cooling.

Current methods for commercial refrigerated/frozen food storage and transportation in grocery, supply chain, delivery, and other food cold chain applications are:

Large scale cooling of warehouse location using conventional HVAC to cold chain compliant temperatures.

In comparison, thermoelectric commercial refrigerated/frozen food storage enables point of need cold chain compliance, efficient use of space, and ability to maintain active cold chain compliance while transporting goods outside of the warehouse.

Ice packs in insulated coolers used for short term food transport and storage. These risk hot/cold spots within the storage volume, and unmonitored excursions from cold chain compliance.

In comparison, thermoelectric commercial refrigerated/frozen food storage enables constant monitoring of cold chain compliance and stable and uniform temperature control throughout the storage space.

A cooler (e.g., for food or other perishable item storage) with active thermoelectric (TEC) cooling to maintain internal temperature within cold chain or customer requirements is disclosed herein. This cooler with active TEC cooling is also referred to herein as an “active cooler”. In some embodiments, the active cooler is used for storage and transportation of refrigerated and frozen food stuffs, medical or biological products, or the like. The active cooler maintains stable and uniform temperature control, powered via wall power, battery, or wireless power transmission.

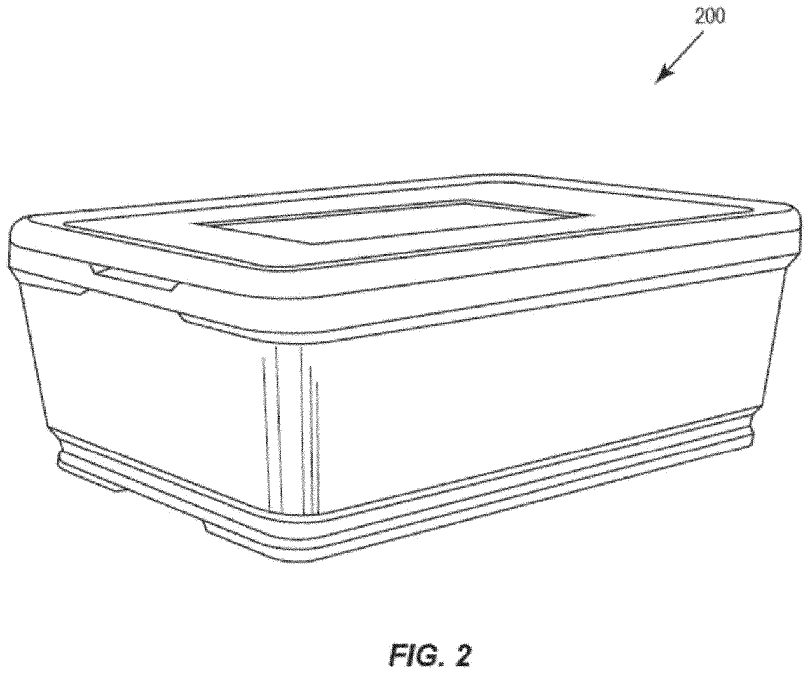

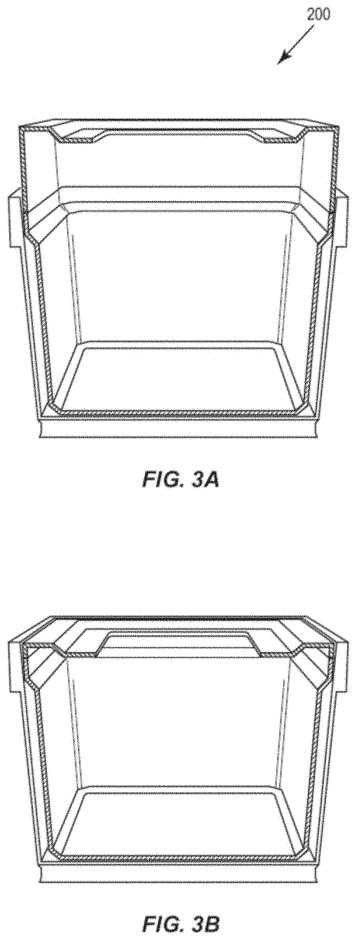

FIG. 2 and FIGS. 3A and 3B illustrate an example embodiment of an active cooler in accordance with embodiments of the present disclosure. FIG. 2 illustrates an active cooler 200 that could be a removable module including a thermal assembly including a thermoelectric heat pump operable to actively cool the interior of the container. The removable module can convert any insulated box to active cooling.

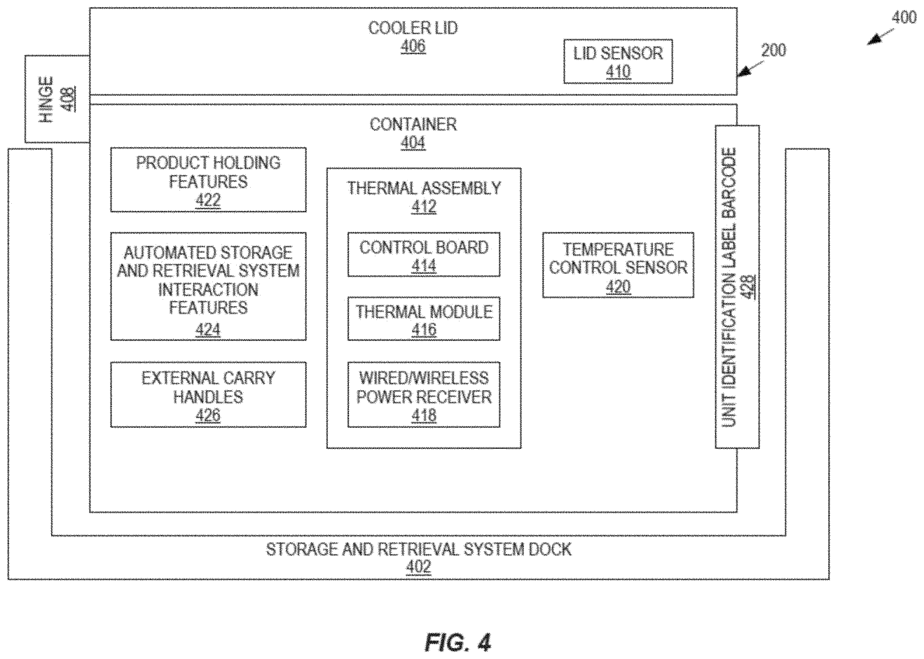

FIG. 4 illustrates a system including an active cooler in accordance with some embodiments of the present disclosure. A schematic diagram of a system 400 including the active cooler 200 and a storage and retrieval system dock 402 in accordance with one embodiment of the present disclosure is illustrated in FIG. 4. As illustrated, the active cooler 200 includes the following components. Note that in some alternative embodiments, the active cooler 200 may not include all of the illustrated components or may include additional or alternative components not illustrated in FIG. 4. The components of the example of the active cooler 200 illustrated in FIG. 4 are:

Container 404: The container 404 (also referred to herein as the “tote” container 404) is an insulated container in which an item(s) to be cooled is placed. The walls of the container 404 may be insulated using a desired insulation (e.g., foam).

Lid 406: The lid 406 is attached to the container 404 via, in this example, hinge 408. The lid 406 can opened and closed to place an item(s) into the container 404 or to remove item(s) from the container 404.

Hinge 408: The hinge 408 attaches the lid 406 to the container 404 such that the lid 406 can be opened and closed, as described above.

Lid Sensor 410: The lid sensor 410 is a senor that senses when the lid 406 is open or closed. An output of the lid sensor 410 is provided to thermal assembly 412 via a wired or wireless connection. The output of the lid sensor 410 may, for example, be used in a control scheme implemented by the thermal assembly 412 to control a TEC used to maintain a desired setpoint temperature within the active cooler 200.

Thermal Assembly 412:

Control Board 414: The control board 414 includes electronics (e.g., a processor(s) such as an Application Specific Integrated Circuit (ASIC), Central Processing Unit (CPU), Field Programmable Gate Array (FPGA), and/or the like as well as Digital to Analog (D/A) converter(s) or similar circuitry to drive the TEC under the control of the processor(s) (e.g. via converting digital output signal from the processor(s) to a corresponding analog signal) in accordance with the control scheme). The control scheme may take into consideration the output of the lid sensor 410 as well as output(s) from temperature sensor(s) within the container 404. The control scheme uses such inputs to control the TEC such that the desired setpoint temperature is maintained within the container 404. In some embodiments, the control scheme includes one or more of the control schemes described in U.S. Patent Application Publication US 2013/0291555, U.S. Patent Application Publication US 2015/0075184, U.S. Pat. Nos. 9,581,362, 10,458,683, and 9,593,871, which are in incorporated herein by reference.

Thermal Module 416: The thermal module 416 includes the TEC as well as various heat transfer components for extracting heat from the container 404 and rejecting the extracted heat to the ambient environment (i.e., the environment external to the active cooler 200). In some embodiments, the thermal module 416 includes a heat pump such as that described in U.S. Pat. No. 9,144,180, which is incorporated herein by reference. For heat extraction (i.e., heat accept) and heat rejection, the thermal module 416 may include, for example, a heat accept system (e.g., thermosiphons or other passive or active heat exchange component(s) for transferring heat from an interior of the active cooler 200 to a cold side of the TEC/heat pump) and a heat reject system (e.g., thermosiphons or other active or passive heat exchange components for transferring heat from a hot side of the TEC/heat pump to the ambient environment).

Wireless/Wired Power Receiver 418: The wireless/wired power receiver 418 includes circuitry for receiving power from a wired power source (e.g., a power outlet or a battery) or from a wireless power source via wireless power transfer.

Temperature Control Sensor 420: The temperature control sensor 420 is a sensor that senses the temperature within the active cooler 200 and provides a signal indicative of this temperature to the thermal assembly 412 for use by the control board 414 to implement the control scheme.

Product Holding Features 422: The product holding features 422 are features (e.g., tray(s), rack(s), etc.) that hold the desire item(s) within the container 404.

Automated Storage and Retrieval System Interaction Features 424: The automated storage and retrieval system interaction features 424 are features (e.g., electronics) that enable interaction between the active cooler 200 and the storage and retrieval system dock 402 (e.g., to enable setting of the desired setpoint temperature, e.g., via a user, to enable reporting of the internal temperature of the active cooler 200, or the like).

External Carry Handles 426: The external carry handles 426 are handles that enable carrying of the active cooler 200 by a user and/or by some automated system for moving the active cooler 200, e.g., within a warehouse.

Unit Identification Label Barcode 428: The unit identification label barcode 428 is a barcode label that enables identification of this particular active cooler 200.

In some embodiments, the active cooler 200 is an active insulated cooler that features a thermoelectric cooler (e.g., a TEC assembly installed directly into the cooler 200 in a removable or built-in module (e.g., the thermal module 416)). In some embodiments, cold chain compliance is maintained by active monitoring and control of thermoelectric assembly (e.g., active monitoring and control of the thermoelectric assembly 412).

In some embodiments, the active cooler 200 achieves temperatures down to 1° C. In some other embodiments, the active cooler 200 achieves temperatures down to −22° C.

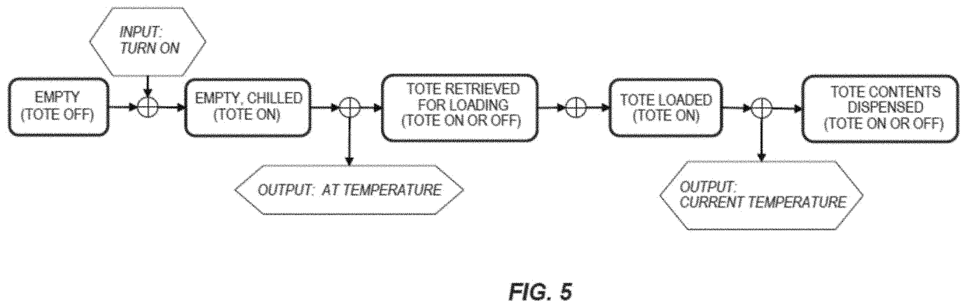

FIG. 5 is a flow chart for communication and control of an active cooler in accordance with some embodiments of the present disclosure.

Additional details are included in U.S. Provisional Patent Application Ser. No. 62/953,771, entitled THERMOELECTRIC REFRIGERATED/FROZEN PRODUCT STORAGE AND TRANSPORTATION COOLER; U.S. patent application Ser. No. 17/135,420, entitled THERMOELECTRIC REFRIGERATED/FROZEN PRODUCT STORAGE AND TRANSPORTATION COOLER, now U.S. Patent Application Publication No. 2021/0199353 A1; and International Patent Application No. PCT/US2020/067172, entitled THERMOELECTRIC REFRIGERATED/FROZEN PRODUCT STORAGE AND TRANSPORTATION COOLER, now International Patent Publication No. WO 2021/134068.

Tote Usage

Totes (i.e., active coolers 200) are intended to be stored in a powered down state until demand dictates that refrigerator or freezer space is needed. This can provide farms, retail clerks, warehousing, or storage systems the capability to have their maximum amount of temperature-controlled space or no temperature-controlled space, as needed by demand. A manual user can locally activate a tote 200, or a central control system can demand the desired capacity to initialize as dictated by a desired control scheme (e.g., IoT algorithms) or direct demand. When the tote 200 reaches the desired set point, it can report locally with visual and or audible alerts and/or report through the network, that it is ready for use. This architecture allows for the most efficient use of space and energy in inventory storage, retail display and customer-order management. Totes 200 can have onboard battery systems that allow for extended off-grid operation, facilitating communications, transport pick-up and delivery services.

Modular Dock

The modular docking system (e.g., a modular system including docks 402) is able to accommodate installations in manual carts, transport vehicles, retail shelving, warehousing racks, automated storage and retrieval systems, Customer Home Kiosks, or the like. All of these systems potentially have the capability to physically secure, power, charge and communicate with the tote 200 through a network connection and report to a central control system. This capability will facilitate the expansion of use case from single-mode operation to multi-purpose mode as adoption expands. In some embodiments, the dock/racking system (e.g., dock 402) provides primary power, either wired or wireless, as well as charging capabilities for onboard battery systems. The dock 402 can act as a power conversion system when necessary to accommodate a wider variety of input power sources. The dock 402 can also serve as a wired network interface and extended range wireless interface that will periodically poll the tote for status and report it to a central control system.

Manual Carts:

Manual carts can be used to transport the totes 200 as a single unit or multi tote array. A battery system can provide extended power to the entire array. These carts can be used outdoors or indoors as needed to facilitate harvest or order collection in a retail setting. The carts will be able to provide extended battery operation for all onboard totes if needed.

Transport Vehicles:

Vehicles transporting inventory or custom orders can be integrated with modular tote storage or racking. These systems may be integrated into a power and network system that is either self-contained or fully integrated into the vehicle power system. This provides indefinite temperature holdover to enable extended range delivery to and from the retail or warehousing location.

Retail Shelving:

Retail shelving can be integrated with the docking system to allow for bulk item display for perishable goods. These can be incorporated in specialty locations as well as end-cap or mid-aisle locations.

Warehousing Racks:

Central warehousing racks can be integrated with the docking system to provide localized temperature-controlled space in any available slot vs. central refrigerated and freezer space. This would enable a more efficient use of space as well as workflow for customer orders to be able to be kept in a single location, reducing the risk of ordering/delivering mistakes

Automated Storage and Retrieval Systems:

Automated inventory and order management systems will be able to better utilize space as needed for standard and perishable items within their limited available spaces. Coupled with centralized control and monitoring, this will enable the most efficient use of space and minimal energy consumption while allowing for coordination of both longer term product storage as well as customer orders to be stored within the same system, while minimizing risk of mistakes or mix-ups when being pulled from storage and into retrieval.

Customer Home Kiosks:

Home delivery Kiosks can allow for compatible docking stations to provide indefinite temperature control for perishable goods. The use of customer Kiosks can enable unattended delivery. This can greatly increase the efficiency and effectiveness of home delivery services by not requiring a person to be at home when the deliveries are being made, while insuring that perishable items are not lost or ruined.

The Intelligent Actively-Cooled Tote is available in both a Refrigerator or Freezer version—with color used to quickly identify between the two. The totes use wireless contact charging and are WiFi and IoT capable, offering real-time insight into your cold chain automation process, leading to an increase in operational efficiencies. In some embodiments, solid-state cooling technology offers the highest possible performance for portable refrigeration and freezing. Developed through rigorous thermal, mechanical, and electrical engineering, the tote's semiconductor-based cooling technology reaches new levels of reliability and efficiency.

By using these actively cooled refrigerated and frozen totes, the barriers that now exist between cooled, frozen, and ambient products are eliminated. Order fulfillment efficiency increases, and cold chain custody is maintained throughout the entire process. Whether it is running a fulfillment operation in a manual environment, like salesfloor picking and storing grocery orders, or acting as a cooled vessel within a Micro Fulfillment Center, the tote is the perfect solution for maintaining cold chain.

Reduce: OPEX, Capital Cost, Labor

Increase: Speed to market, Flexibility to scale without added cost, Order throughput

Decrease: Order fulfillment & delivery time and cost, Customer wait time during pick-up, Physical footprint

Remove the need for: Passive cooling like dry ice and gel packs, Tri-temperature trucks, Temperature-controlled rooms & walk-in/reach-in freezers or coolers

By using these actively cooled refrigerated and frozen totes, the barriers that now exist between cooled, frozen, and ambient products are eliminated. Order fulfillment efficiency increases, and cold chain integrity is maintained throughout the entire process.

Additional details are provided about: Automated Systems, Picking and Storage, Pickup and RX, Delivery

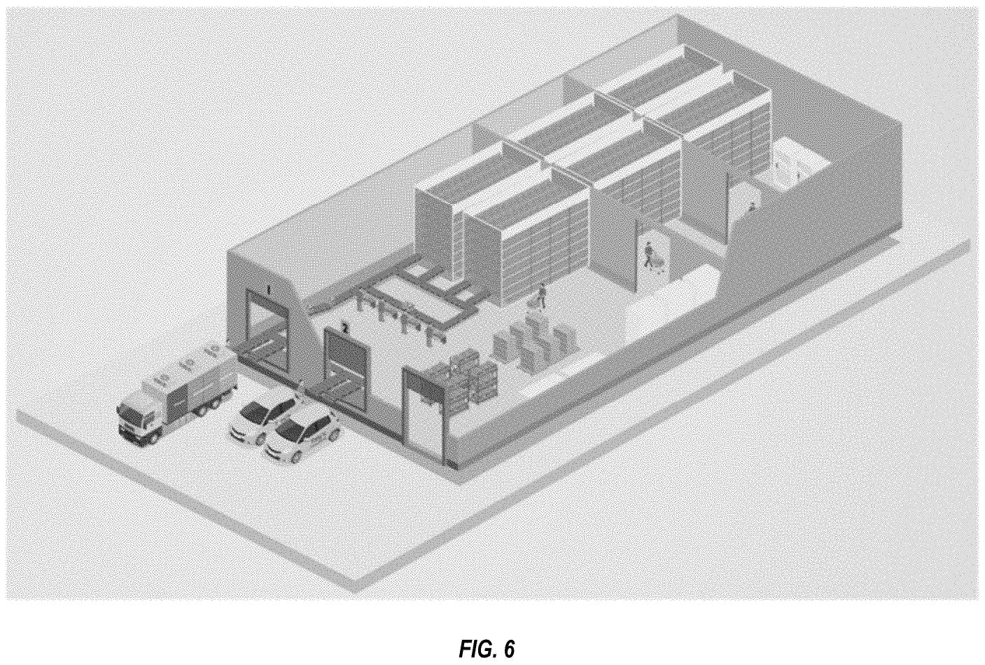

FIG. 6 illustrates an embodiment where a fulfillment center includes three separate temperature areas.

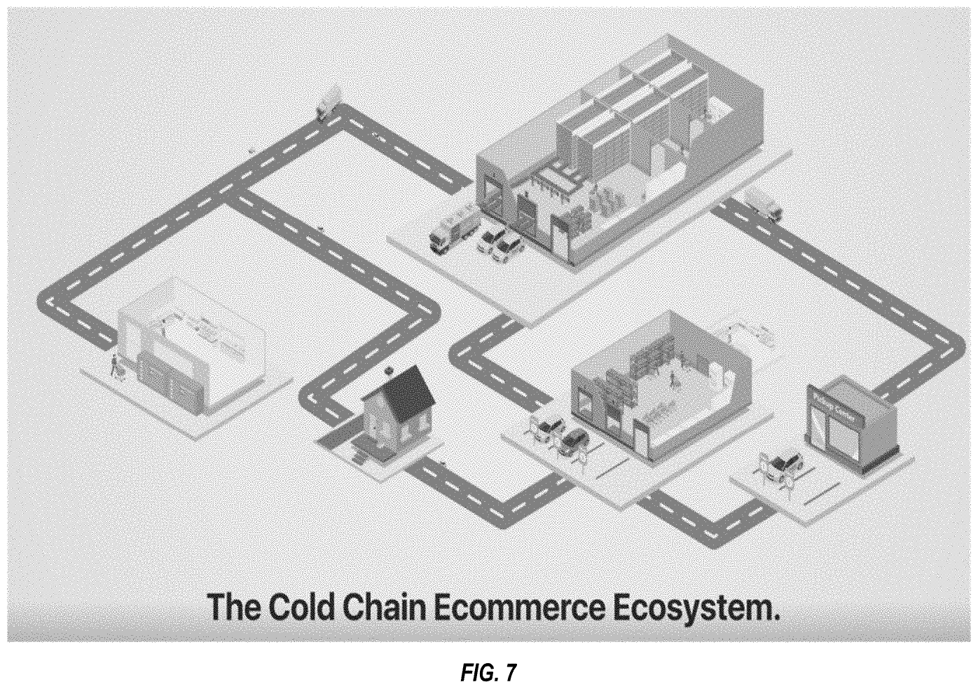

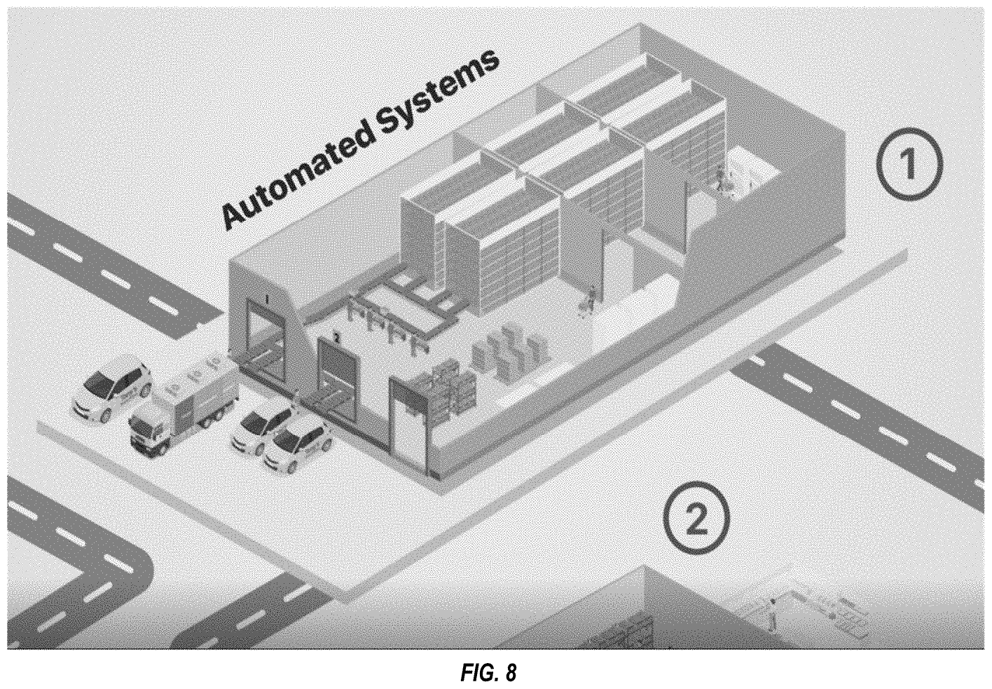

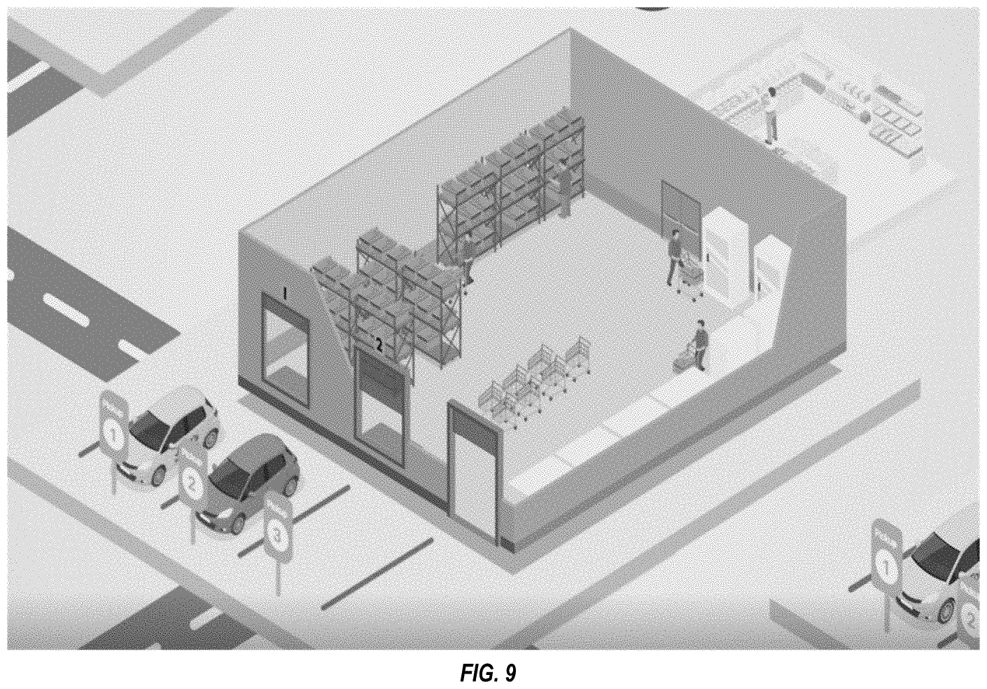

FIG. 7 illustrates an overview of the cold chain ecosystem. FIG. 8 illustrates automated systems used with three different temperature areas. FIG. 9 shows room temperature storage and refrigeration/freezer spaces.

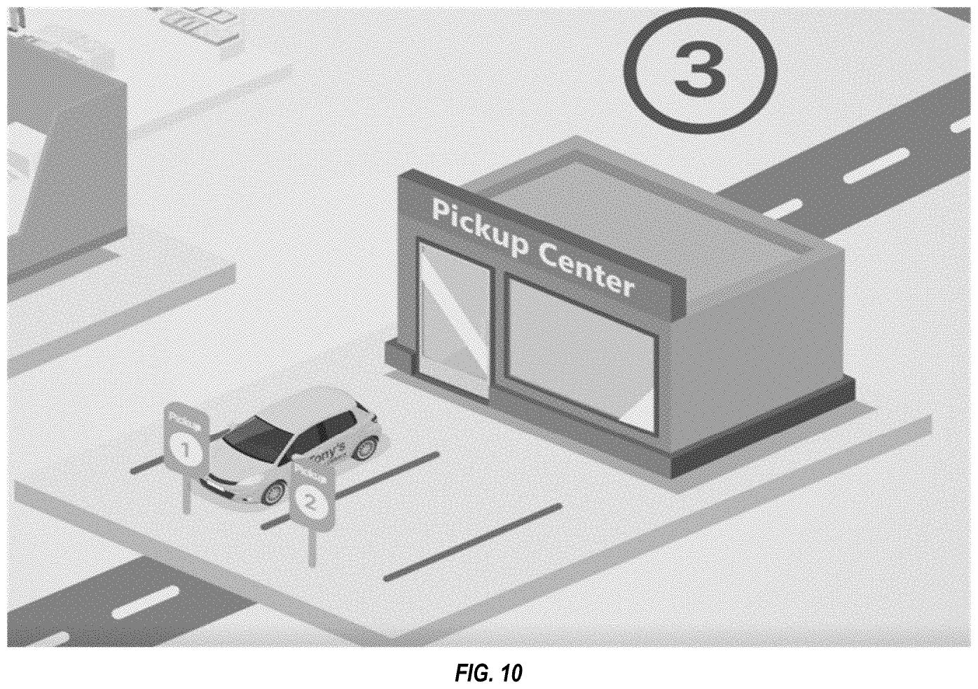

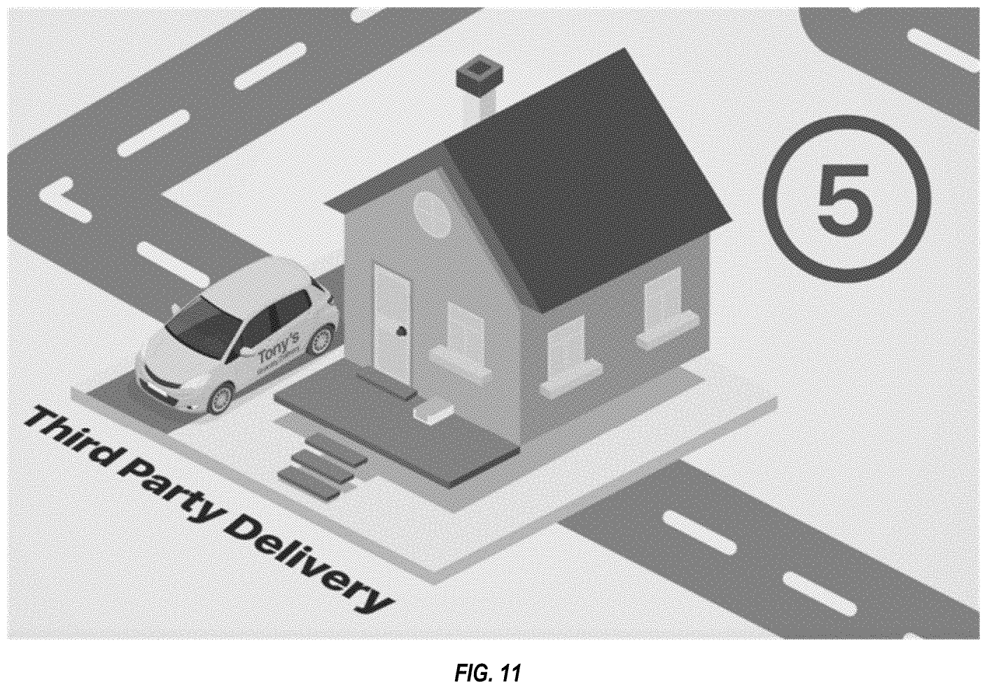

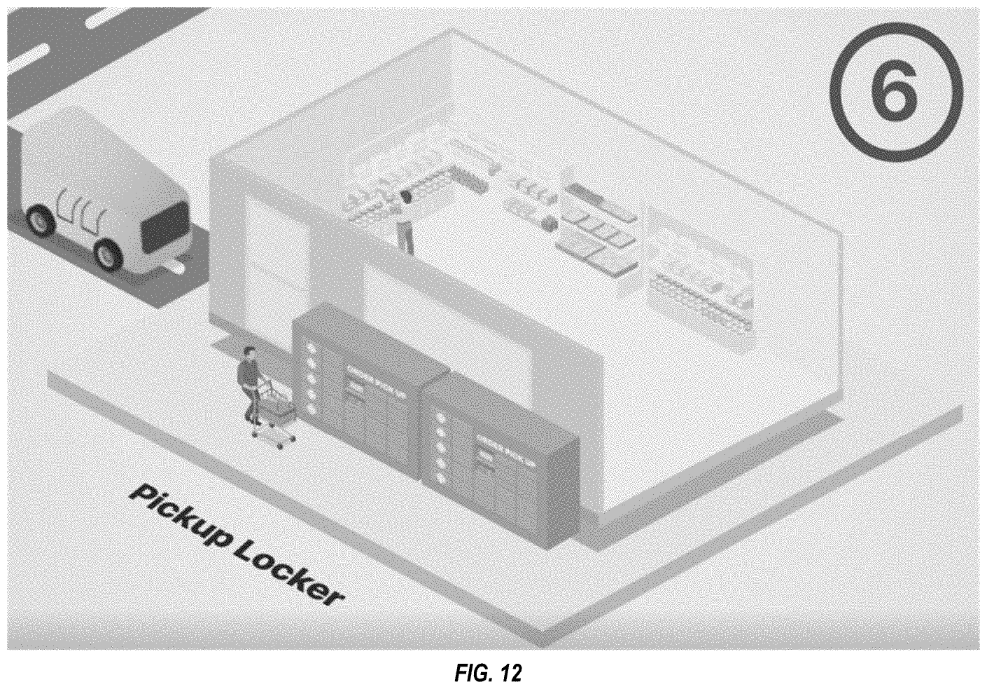

FIG. 10 shows a pickup center that could be the outside of FIG. 9, for instance. FIG. 11 illustrates a home delivery embodiment. FIG. 12 illustrates a pickup locker.

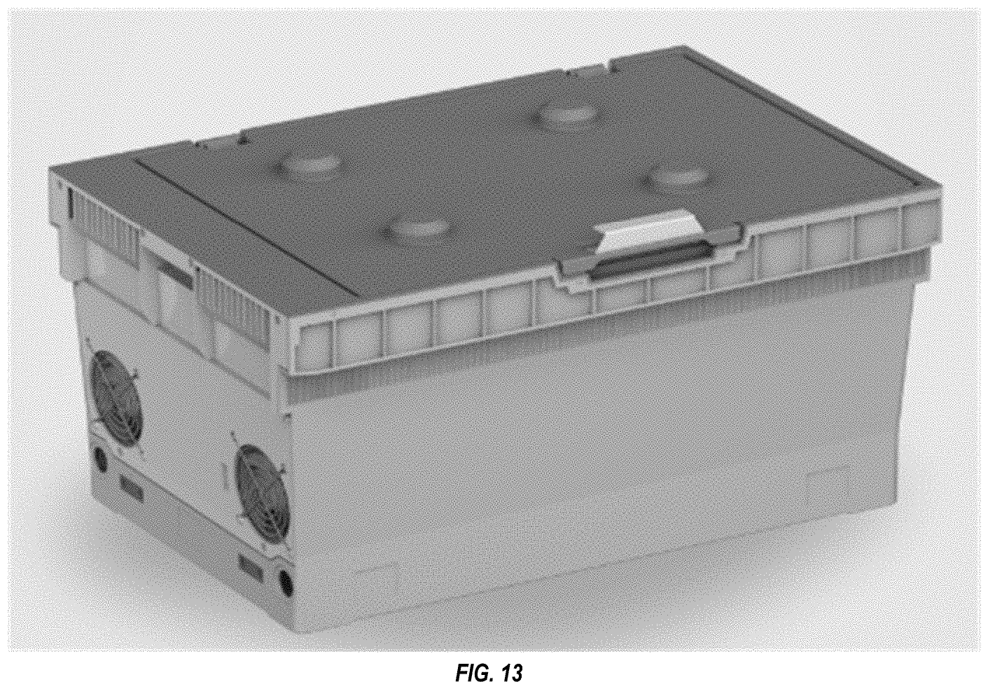

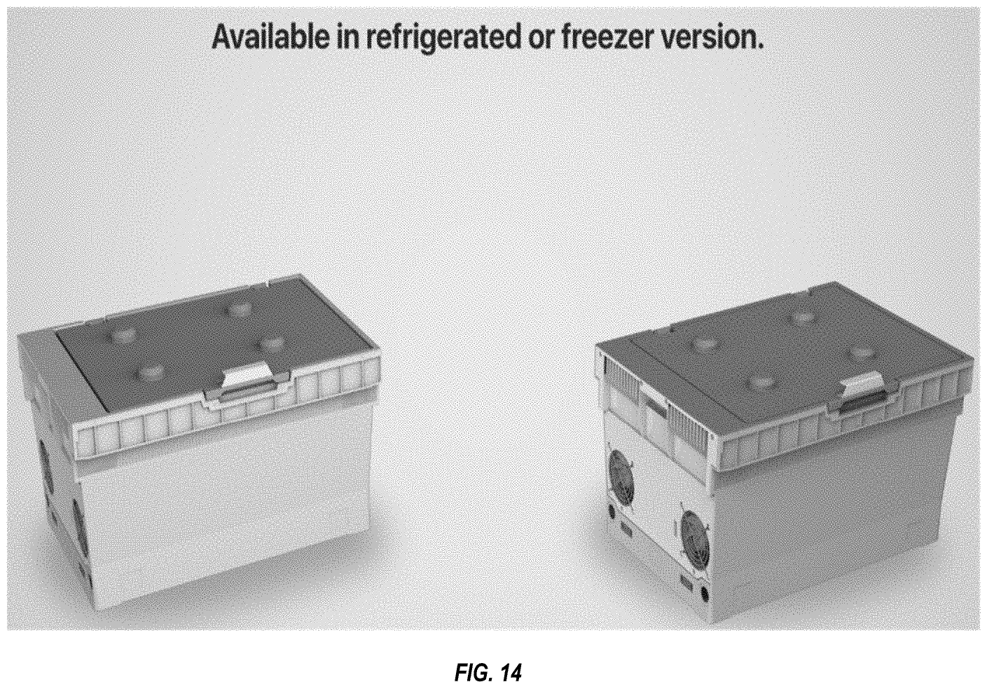

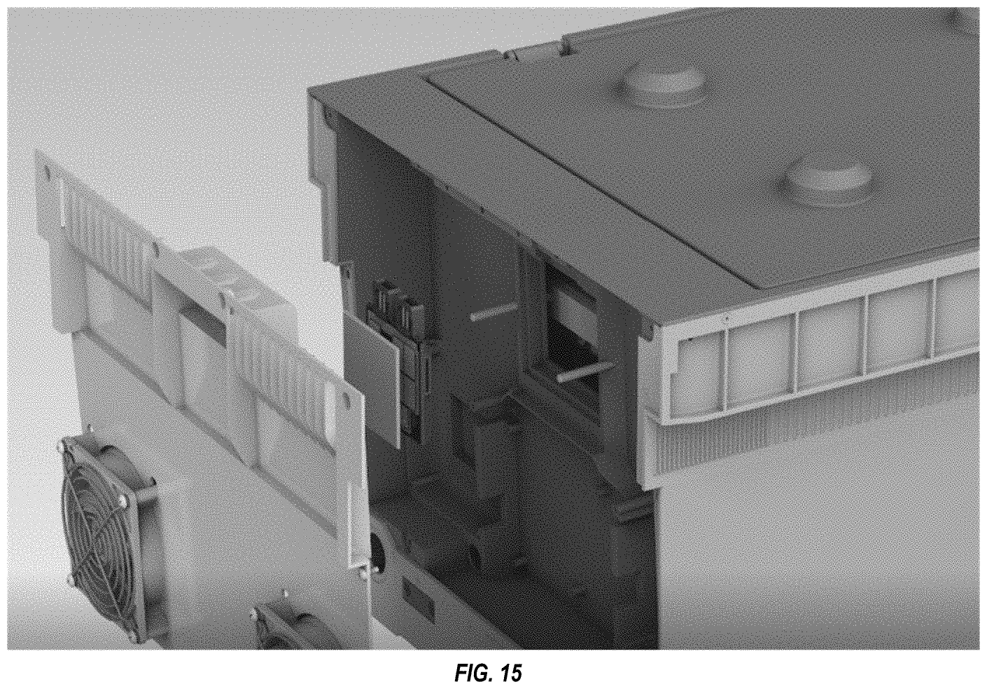

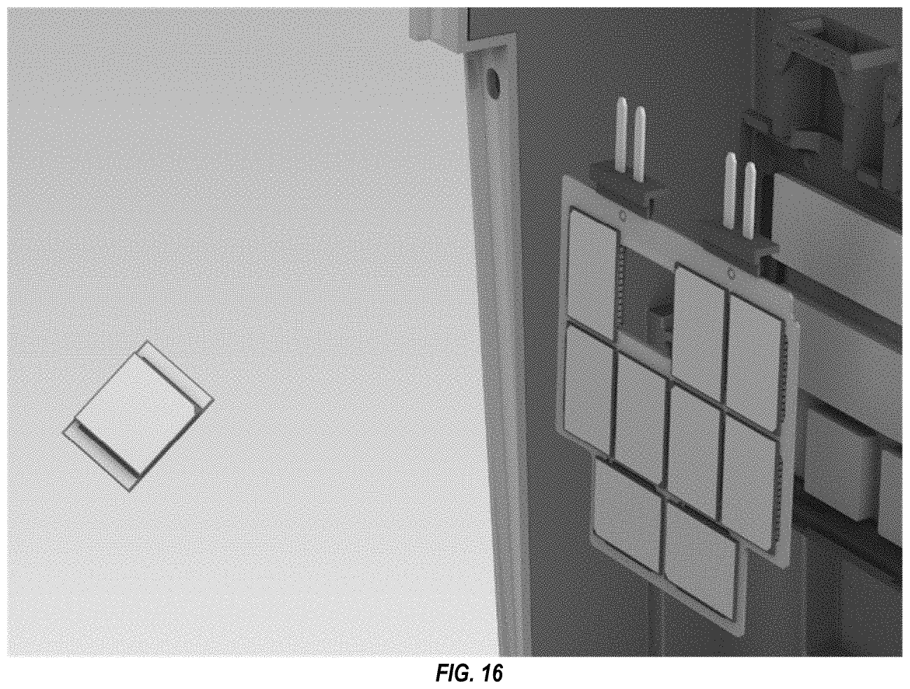

FIG. 13 illustrates an example of a tote as discussed herein. FIG. 14 illustrates that different versions of the totes could be used in refrigerator or freezer versions. FIG. 15 shows an exploded view of the tote that includes a thermoelectric unit as discussed herein. FIG. 16 shows individual thermoelectric units included on a board as part of the unit.

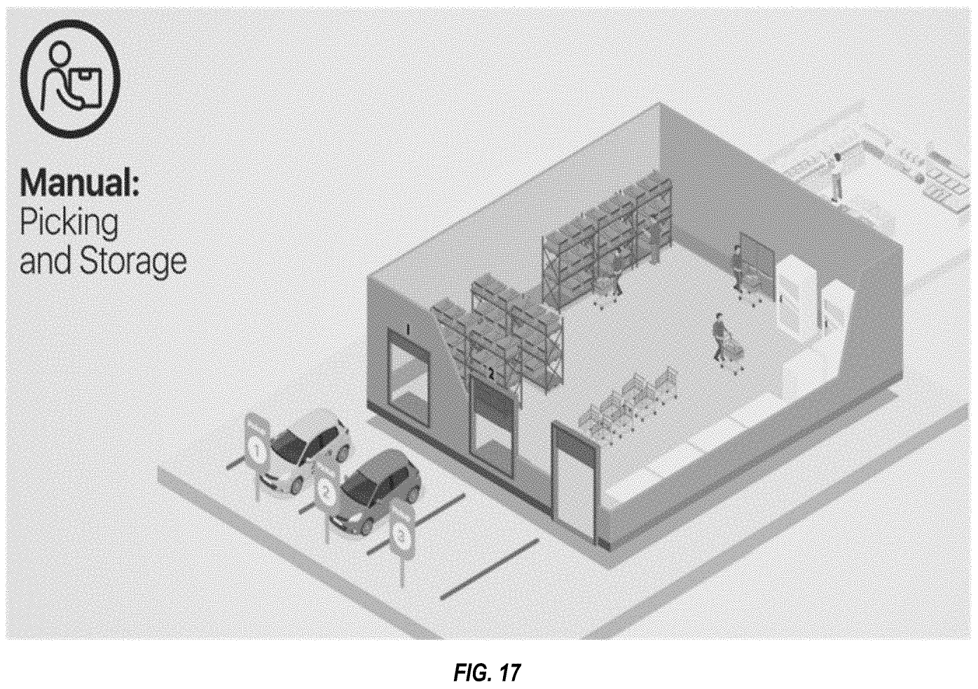

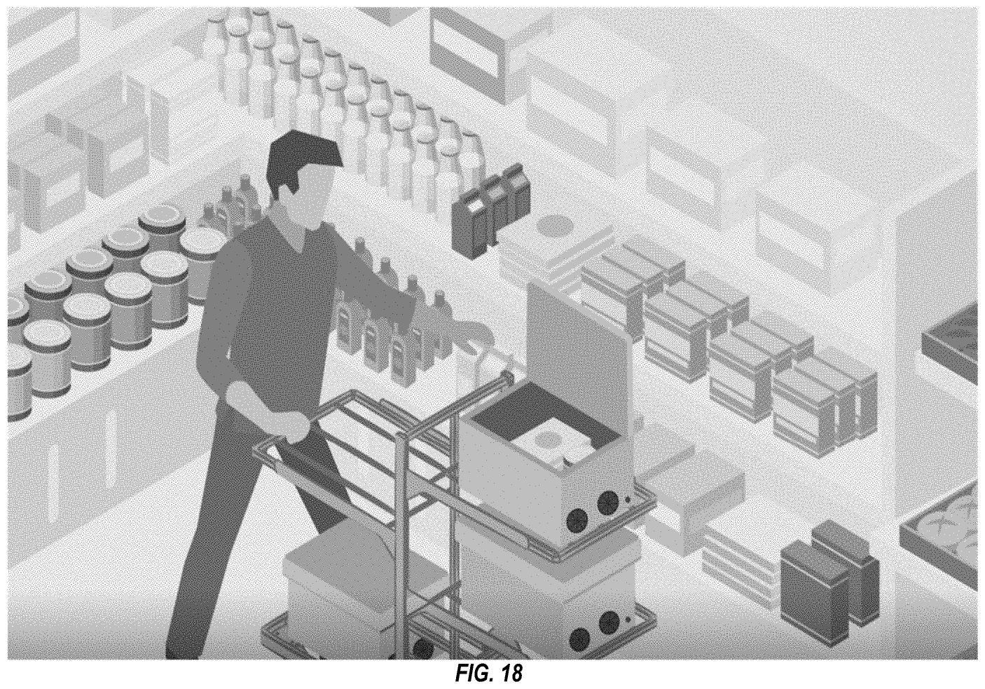

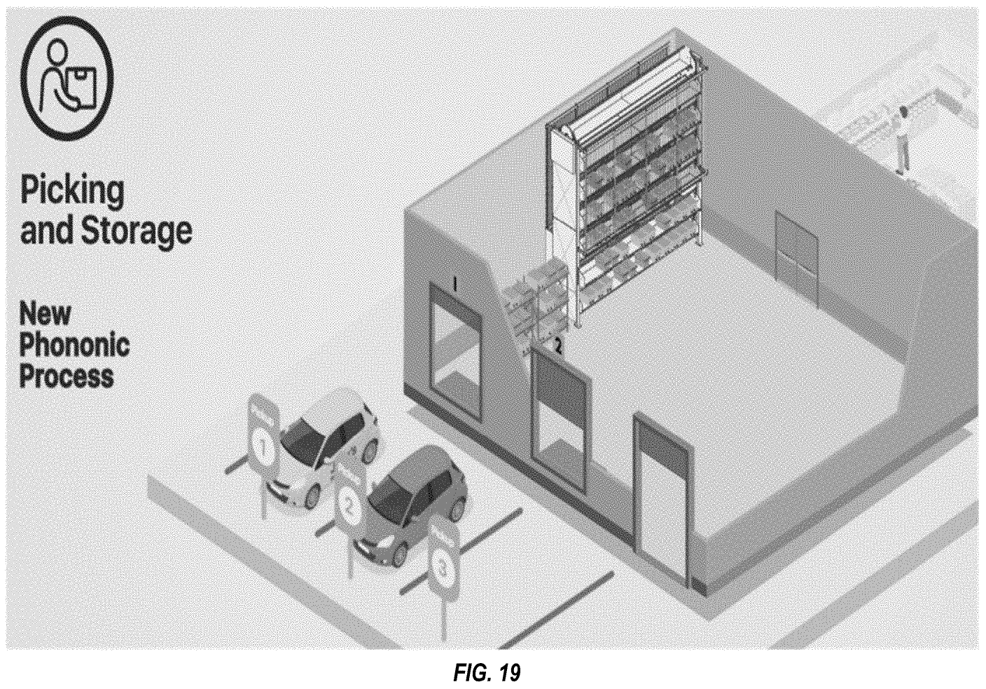

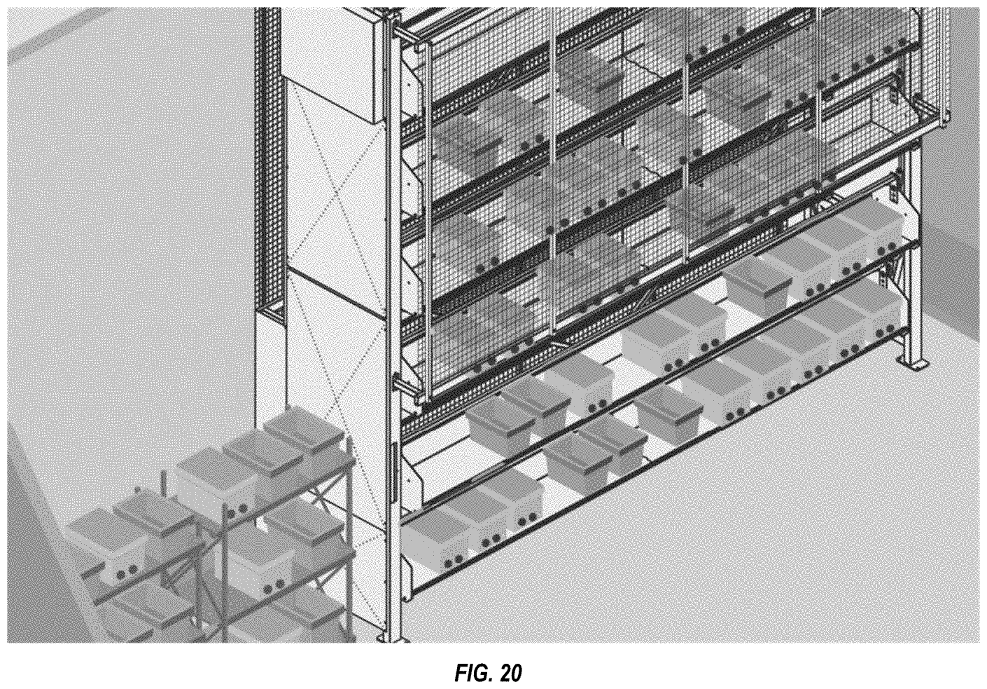

FIG. 17 shows room temperature storage and refrigeration/freezer spaces. FIG. 18 illustrates picking products directly into a tote. This can minimize the amount of time that the products are out of temperature. FIG. 19 shows a pickup center where the various totes are maintaining the temperatures instead of having three separate temperature areas. This could reduce the energy and economic impact of these centers. This could also assist in automatic processing. FIG. 20 shows various types of totes stored in the same racks with additional features that might make automatic systems more efficient.

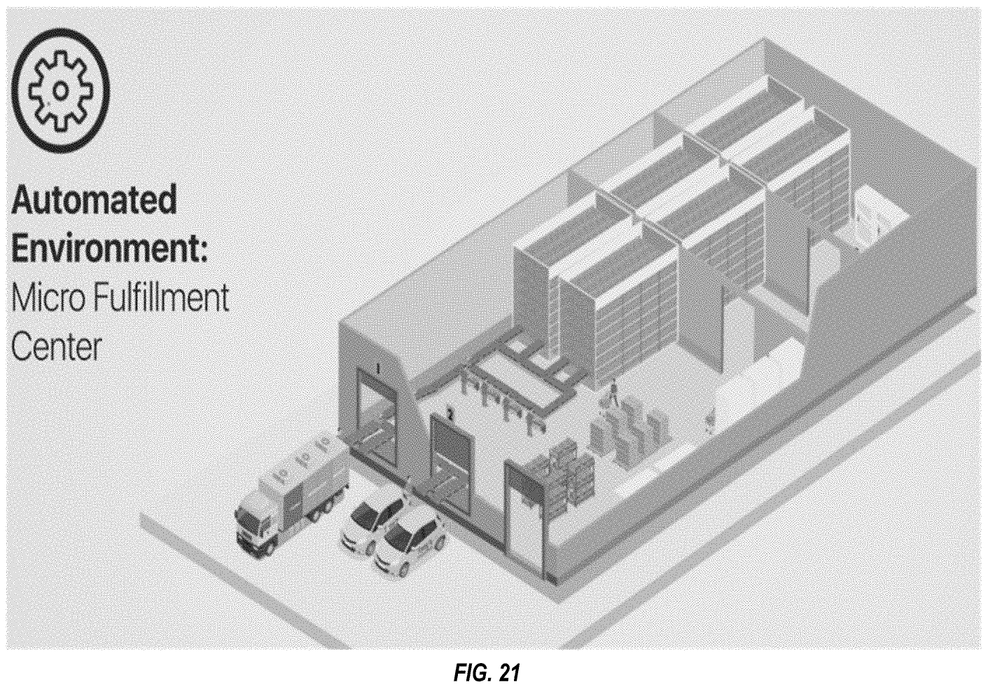

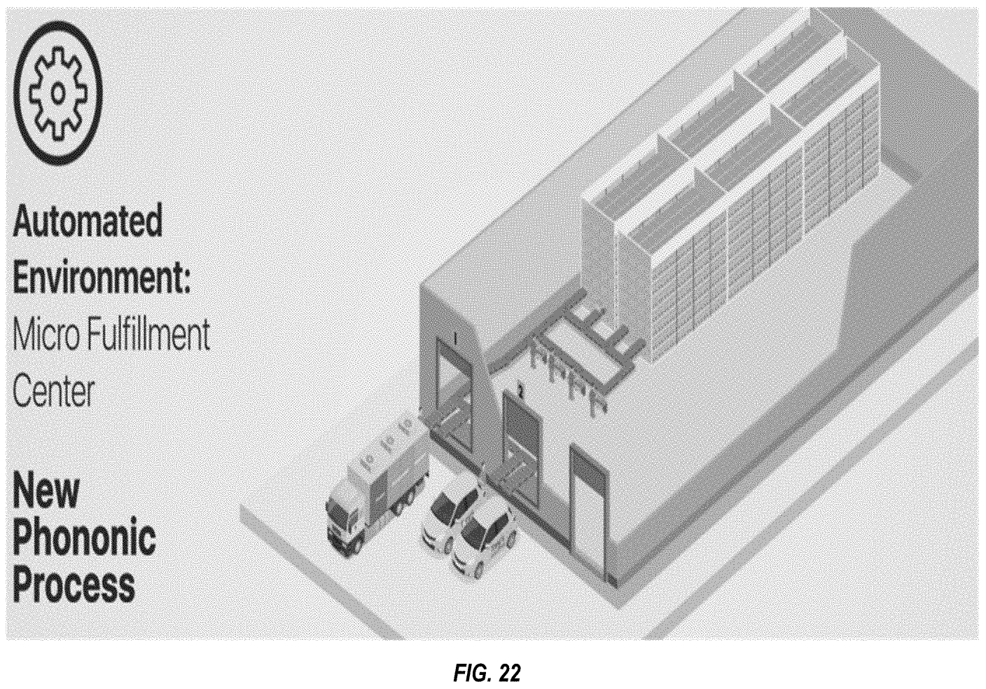

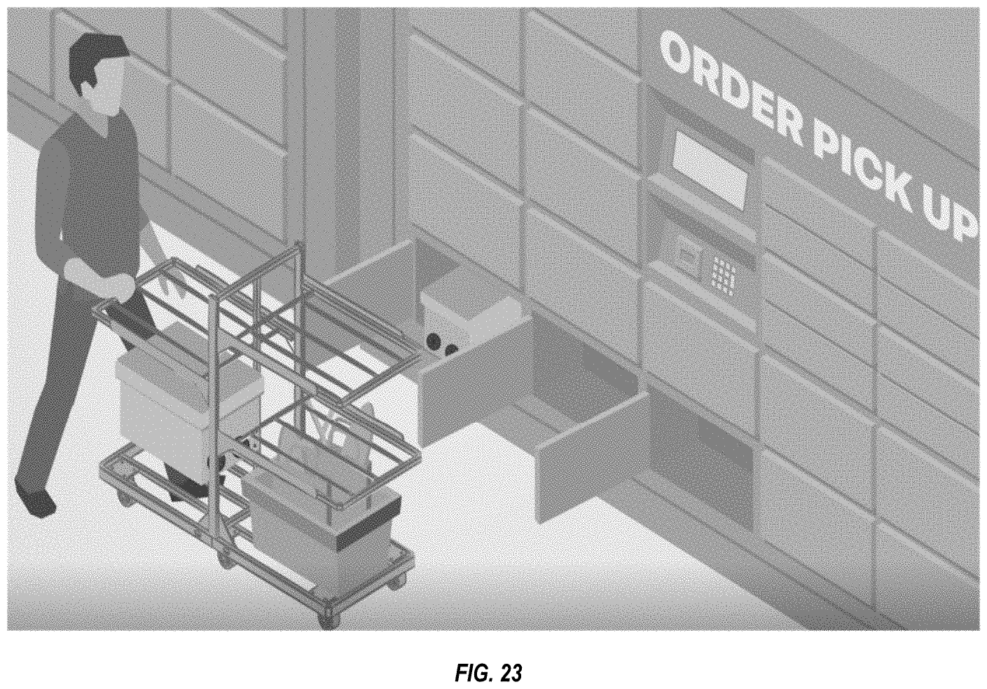

FIG. 21 illustrates an automated environment for a micro fulfillment center with three different temperature zones. FIG. 22 illustrates an automated environment for a micro fulfillment center with only one temperature zone necessary since the totes can maintain the proper temperatures. FIG. 23 shows an order pick up area where the totes maintain the temperature and the lockers do not need to be temperature controlled.

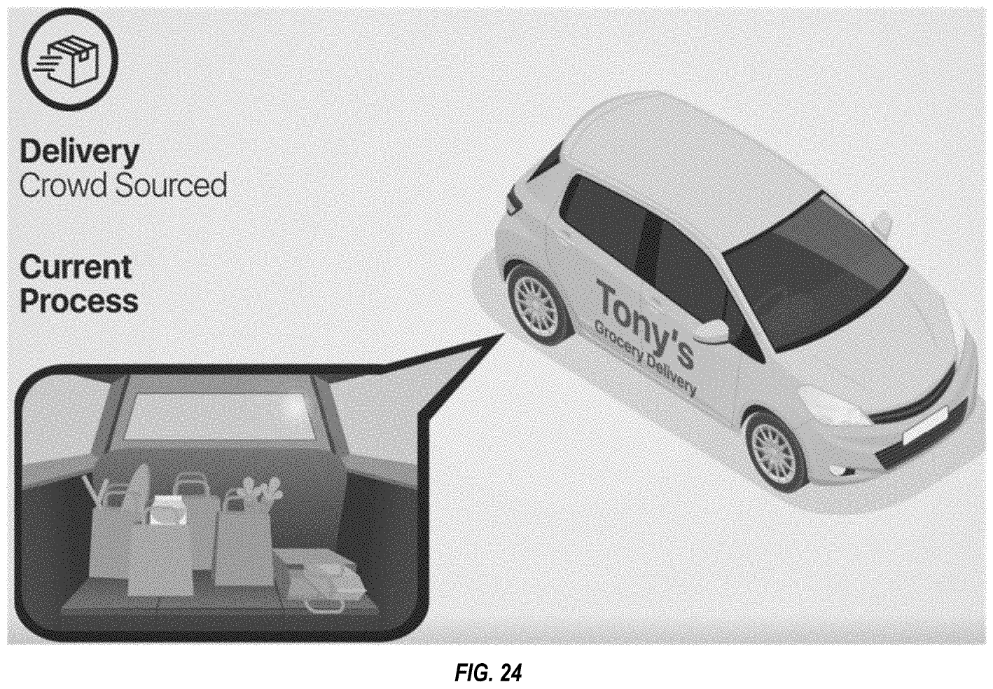

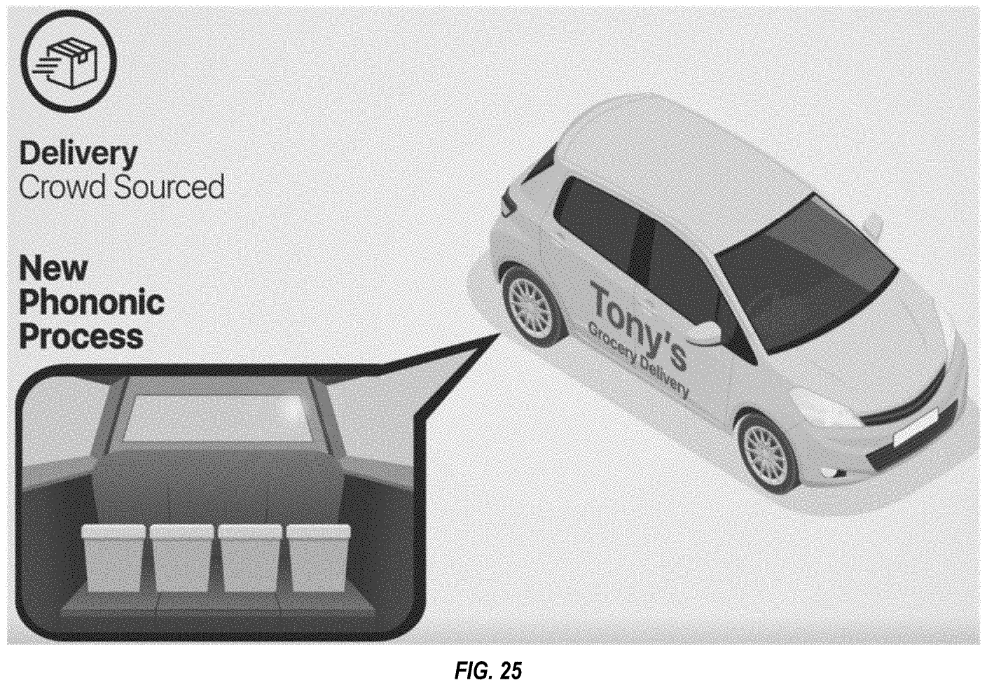

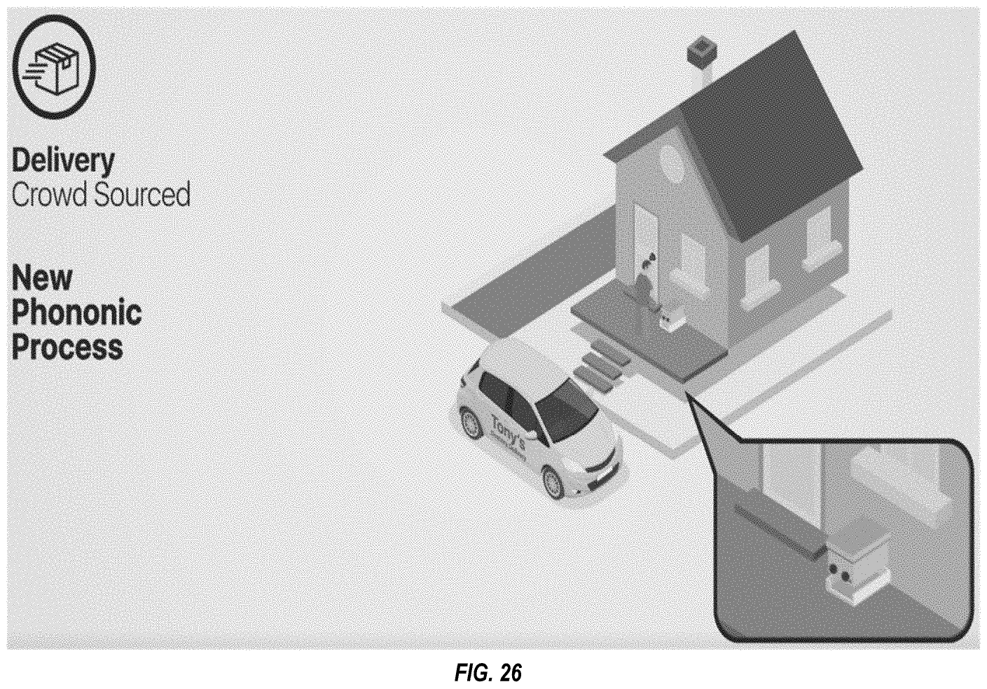

FIG. 24 shows a delivery service where the orders are included in the back seat. These can include different temperature requirements. Some ice packs or other passive cooling is used to maintain these temperatures. However, this reduces the amount of time before the deliveries must be completed. FIG. 25 shows the use of the totes to deliver the orders. This can maintain the correct temperature longer and/or more precisely. This might enable more deliveries per pick up and provide increased customer satisfaction. FIG. 26 illustrates an embodiment where the tote can be left with the delivery to further increase the time that the order is the correct temperature. In this figure, there could also be a charging station there to make the delivery more convenient. Otherwise, the battery operation could keep the delivery cold, or passive cooling could keep the delivery cold.

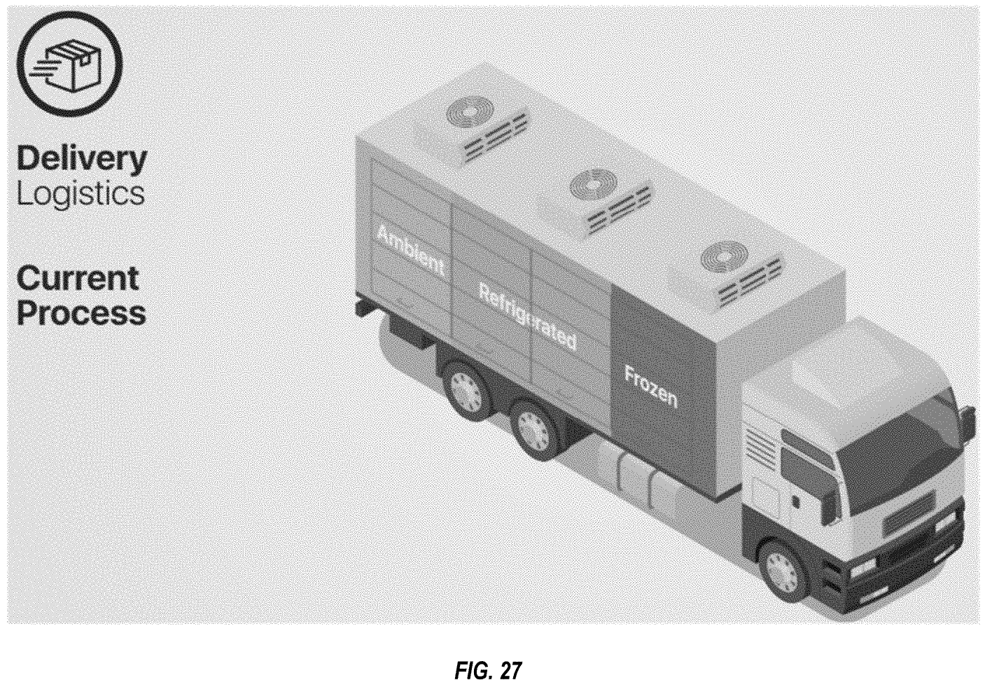

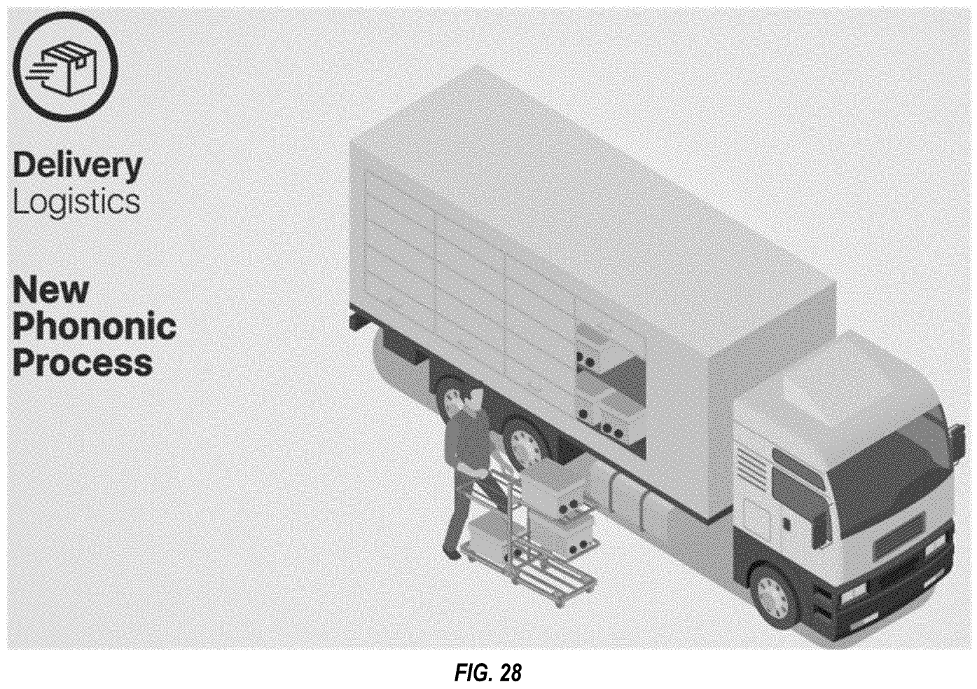

FIG. 27 shows the standard tri-temperature truck that is used for deliveries. This might include several different cooling systems that must be carried around regardless of whether they are currently needed. FIG. 28 illustrates a delivery truck which does not need refrigeration systems or needs less. In this embodiment, the totes provide the proper temperatures for the various goods. This can make the trucks more efficient in many ways. This also adds configurability. If an entire truck is needed for a specific temperature, this can be easily accomplished as opposed to the standard truck shown in FIG. 27. These trucks might include charging capabilities or other amenities.

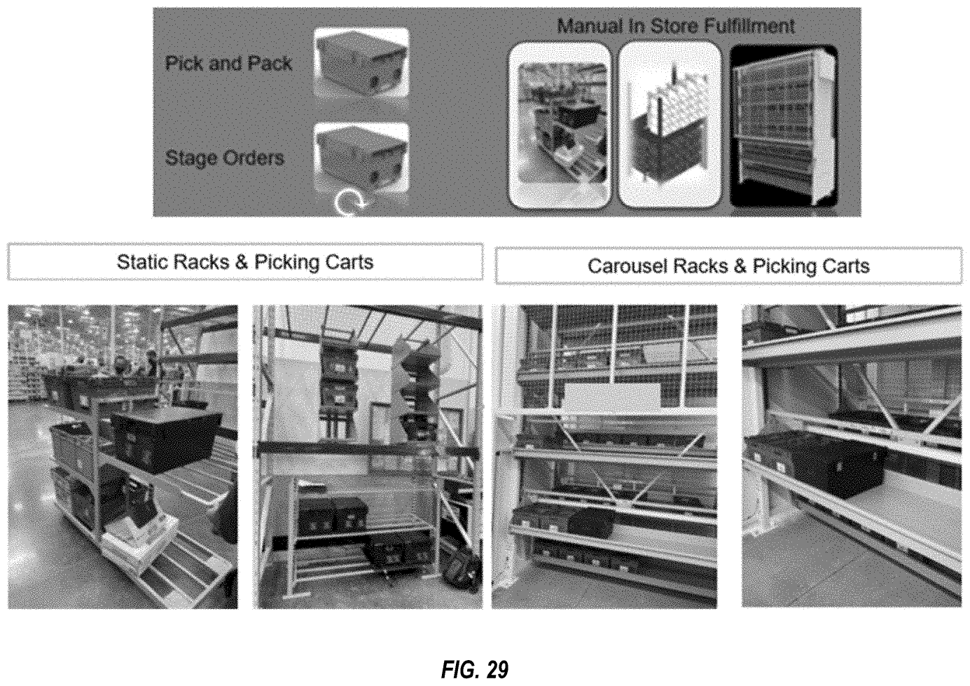

FIG. 29 shows different uses for the totes. This includes static racks, packing carts, and/or carousel racks. In some embodiments, these can include power delivery mechanisms and additional features to aid in automation.

The recent changes created by a steep increase in demand and growing competition within the market are now driving new innovations in logistics to answer the demand for direct to consumer grocery supply chains.

Two fairly new grocery fulfillment technological advancements are: MFCs and CFCs (Customer Fulfillment Centers) or automated online supermarkets which are really just the beginning of what digital grocery shopping can look like.

More grocers are considering moving to micro-fulfillment centers that can lower operating expenses. These actively cooled tote allows you to have seamless operations within Micro Fulfillment Centers or Automated supermarkets.

Actively-cooled inventory or order totes can store perishable goods versus having to build refrigerated or frozen warehouses.

This also eliminates tri-temp buildings and/or trucks.

It allows you to operate in an associate-friendly, ambient environment, which can also lead to a decrease in energy costs and maintenance warehouses and automated systems.

Solid-state refrigeration means easier maintenance and industry leading dependability.

Due to strict cold chain compliance regulations, personal shopper associates have to adhere to specific time limits while picking chilled or frozen products. Most are limited to a mere 30 minutes during their time shopping these categories which can sometimes be disruptive to their overall picking time.

By using an actively refrigerated tote during their pick walks, they are now able to continue their entire route without having to return to the backroom due to a time constraint or concern over product quality.

Also, due to the universal dimensions of the tote, retailers are able to leverage their current assets like dollies, pick carts, racking, MFCs, etc., which can be a huge capital savings.

As grocers look to increase their order volume at stores, they are often limited to the amount of physical space available in a backroom or order storage area.

With the actively cooled totes, in conjunction with automated vertical storage or existing racking systems, retailers are now able to accommodate future workflow flexibility by leveraging and optimizing existing space.

With the tote being mobile in nature, the retailer is able to move things around as needed versus the immobility seen today with reach-in cases which are stagnant.

Also, as the order ratio between the number of products that are ambient versus chilled versus frozen fluctuates, the totes are able to flex with demand. Whereas conventional solutions like reach-in cases are more stagnant.

Now more than ever, we're seeing an increase in the number of retailers adopting and expanding their Buy Online, Pickup In Store (BOPIS) solutions, like in-store and drive-up Pickup and Lockers.

Current refrigerated locker solutions do not offer the modularity and plug and play capabilities that the tote can offer.

As demand fluctuates for the need to have a refrigerated versus frozen locker space, the tote can accommodate these needs by simply plugging into however many spaces needed. Most retailers are sticking with offering ambient lockers, which only helps with dry goods or GM products and would require an associate to retrieve perishables in another area.

As an eCommerce category, grocery has lagged behind most other retail sectors for many reasons, some of which are purely logistical. Delivering refrigerated and frozen items is challenging, especially when you lose control the second product leaves your building. This can be worrisome for some since there is no control over whether the third-party delivery driver's car has a functioning climate control.

Grocers currently rely on passive cooling solutions like gel or ice packs to maintain temperature controls, which are not reliable or sustainable. Typical grocery deliveries are done one at a time, but with the actively cooled tote, you can acquire cost efficiencies once thought unobtainable by optimizing routes through batched orders.

The current standard for delivering goods is one hour from pick up, which prohibits the number of reachable customers within that time frame. With an actively cooled tote, the delivery radius can be substantially increased to reach more customers with fewer trips to and from the fulfillment center.

With grocers scrambling to identify new innovations to decrease delivery times for their customers, while also not increasing labor costs, there is a push to develop Autonomous Vehicles, sidewalk bots, and porch delivery and storage systems. Most of these technologies still have a need for effectively cooling perishable items as they're transported to the customer's home. With the tote being mobile and actively cooled, the problem is solved.

In some embodiments, the Intelligent Actively Cooled Tote gives you the freedom to design your fulfillment solution and/or to achieve a strong ROI and win the battle of fulfillment.

For more details, the interested reader is directed to U.S. Provisional Patent Application Ser. No. 62/953,771, entitled THERMOELECTRIC REFRIGERATED/FROZEN PRODUCT STORAGE AND TRANSPORTATION COOLER; U.S. patent application Ser. No. 17/135,420, entitled THERMOELECTRIC REFRIGERATED/FROZEN PRODUCT STORAGE AND TRANSPORTATION COOLER, now U.S. Patent Application Publication No. 2021/0199353 A1; and International Patent Application No. PCT/US2020/067172, entitled THERMOELECTRIC REFRIGERATED/FROZEN PRODUCT STORAGE AND TRANSPORTATION COOLER, now International Patent Publication No. WO 2021/134068. These applications are hereby incorporated herein by reference in their entirety.

Ducting:

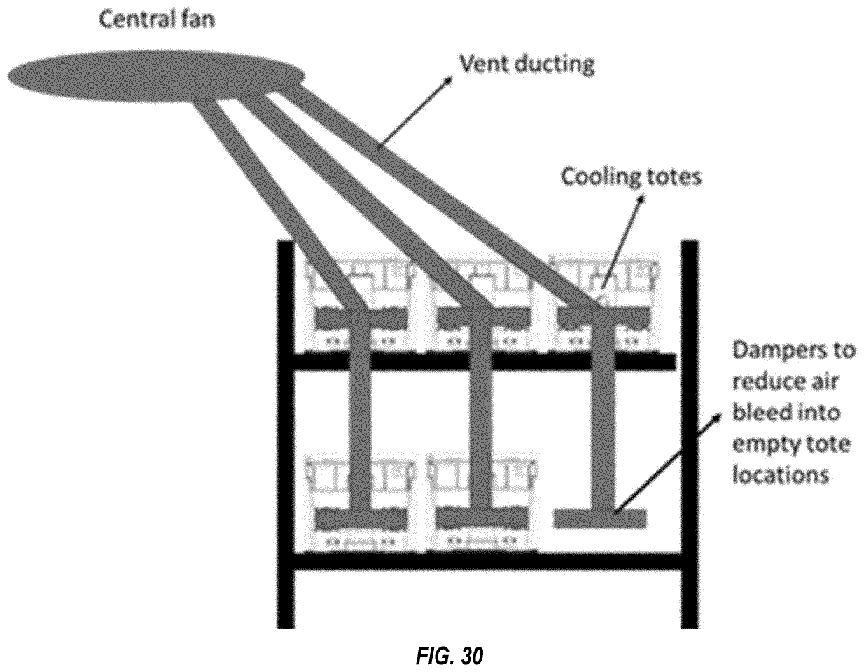

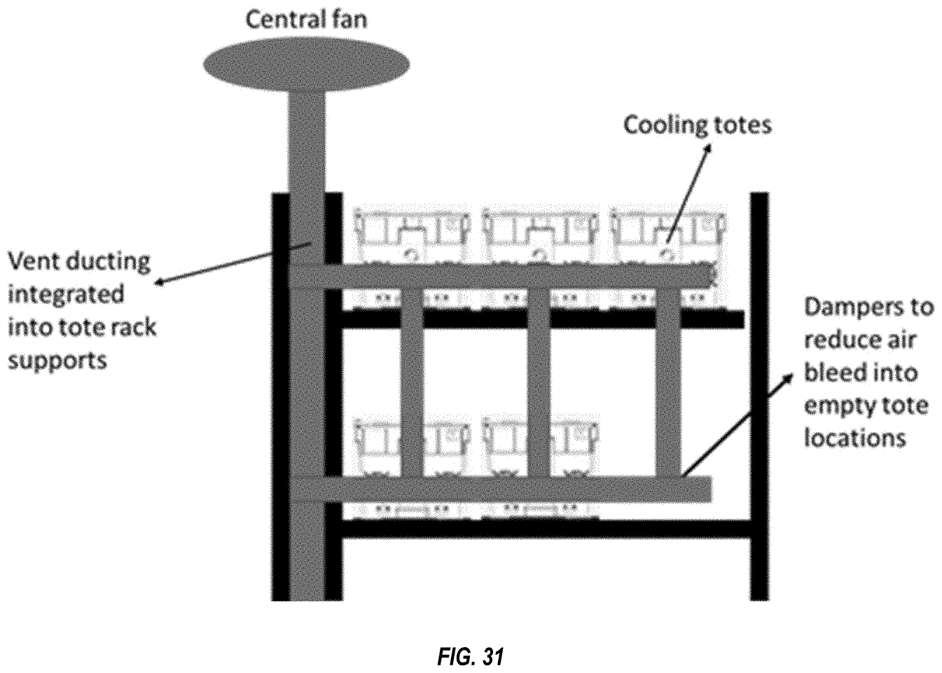

FIG. 30 and FIG. 31 illustrate various ways that vent ducting can be integrated into a tote rack. For more details, the interested reader is directed to U.S. Provisional Patent Application Ser. No. 63/402,862, entitled THERMAL MANAGEMENT OF ACTIVELY COOLED TOTES USED IN LAST MILE DELIVERY OF FOOD filed on Aug. 31, 2022. This application is hereby incorporated herein by reference in their entirety.

Heat from totes can be removed by actively ducting the hot reject air to outside. A central vent fan will provide airflow to outside. Individual totes can be connected to it using flexible ducting. The connection can involve a spring-loaded mechanism to push the tote against a compressible gasket and seal the duct to the exhaust of the tote. A damper can be used to reduce air from moving back into the van when a tote location is not occupied.

The ducting can also be integrated into the support structure of racking to reduce the space occupied by ducting. The support beams for racking can be made hollow and ducting can be through these hollow channels.

To further improve air exchange from outside, vents can be included in the side of the van to improve air inlet from outside. These vents can be angled to increase the amount of air coming in as the van gains speed. Additional venting can be included in the back to enhance turbulence and air mixing inside the van.

Another method to remove the heat from the tote is to use a liquid cooling loop. The tote reject heat exchanger can be made of a flat plate mated to a liquid cold plate which stays stationary in the van. The liquid can be cooled using a radiator or a refrigerant chiller loop.

Those skilled in the art will recognize improvements and modifications to the preferred embodiments of the present disclosure. All such improvements and modifications are considered within the scope of the concepts disclosed herein and the claims that follow.

1. A method of operating a tote to enable cold chain delivery, the method comprising one or more of:
providing storage of one or more cold products in the tote in a micro-fulfillment center;
facilitating a pick and pack process of one or more cold products where the one or more cold products are picked from a tote and/or are packed into a tote; and
dispensing the one or more cold products using a tote.

2. The method of claim 1 wherein dispensing the one or more cold products using the tote further comprises:
dispensing the one or more cold products using the tote to one or more of:
a pickup location;
a curbside location;
a distribution locker; and
a home or office.

3. The method of claim 1 wherein dispensing the one or more cold products using the tote further comprises: delivering the tote to a powered docking station.

4. The method of claim 1 further comprising: storing the tote on a powered rack or docking station.

5. The method of claim 1 further comprising: the tote providing active cooling to the one or more cold products during at least some portion of the cold chain delivery.

6. The method of claim 1 wherein multiple totes with different temperature requirements can be stored in the same ambient environment.

7. The method of claim 1 wherein the tote comprises wireless and/or contact charging capabilities.

8. The method of claim 1 wherein the tote comprises monitoring abilities that can be reported locally and/or through one or more wireless interfaces.

9. The method of claim 8 wherein a cold chain compliance of the tote can be monitored during the cold chain delivery.

10. The method of claim 1 wherein a tote is used while picking the one or more cold products, such as in a retail environment, either manually or via automation.

11. The method of claim 10 wherein using the tote while picking the one or more cold products comprises using a cart or dolly that can provide power or communications to the tote.

12. The method of claim 1 wherein the tote is stored using automated vertical storage or existing racking systems.

13. The method of claim 12 wherein the automated vertical storage or existing racking system comprises a rack that can provide power or communications to the tote.

14. The method of claim 1 further comprising:
providing the tote to a third party for transportation while maintaining active cooling of the tote.

15. The method of claim 1 further comprising:
using the tote to increase the delivery radius (e.g., to reach more customers) with fewer trips to and/or from the fulfillment center.

16. The method of claim 1 wherein the tote comprises a thermoelectric cooler.

17. The method of claim 1 wherein the tote comprises:
a container;
a lid attached to the container such that the lid can be opened to access an interior of the container and closed to seal the container; and
a thermal assembly comprising a thermoelectric heat pump operable to actively cool the interior of the container.

18. The method of claim 17 wherein the thermal assembly further comprises processing circuitry configured to control the thermoelectric heat pump in accordance with a control scheme.

19. The method of claim 18 wherein the processing circuitry is configured to control the thermoelectric heat pump in accordance with the control scheme to maintain a desired setpoint temperature within the interior of the container.

20. The method of claim 18 wherein the processing circuitry is configured to offer remote monitoring and/or control.

21. The method of claim 20 wherein the processing circuitry is configured to offer the remote monitoring and/or control for one or more of the group consisting of: on board access, wireless access, and networked access.

22. The method of claim 17 wherein the thermal assembly further comprises a heat accept system and a heat reject system.

23. The method of claim 22 wherein the heat accept system comprises components for transferring heat from an interior of the active cooler to a cold side of the thermal assembly and the heat reject system comprises components for transferring heat from a hot side of the thermal assembly to the ambient environment.

24. The method of claim 17 further comprising circuitry for receiving power from a wired power source and/or from a wireless power source via wireless power transfer.

25. The method of claim 17 further comprising automated storage and retrieval system interaction features that enable interaction between the active cooler and a storage and retrieval system dock.

26. The method of claim 17 wherein the thermal assembly comprises a removable module.

27. (canceled)
